(19) United States
(12) Patent Application Publication
(10) Pub. No.: US 2005/0188037 A1
(43) Pub. Date: Aug. 25, 2005

(54) Sensor-driven message management apparatus

(76) Inventor: Yoshitaka Hamaguchi, Nara (JP)

Correspondence Address: RABIN & Berdo, PC, 1101 14TH STREET, NW, SUITE 500, WASHINGTON, DC, 20005, US

(21) Appl. No.: 11/041,285

(22) Filed: Jan. 25, 2005

(30) Foreign Application Priority Data
Jan. 29, 2004 (JP) 2004-020934

(51) Int. Cl. G06F 15/16

(52) U.S. Cl. 709/206

(57) ABSTRACT

A message management apparatus receives messages with associated sensor conditions, compares the sensor conditions with corresponding sensor outputs, and displays the messages according to the results. If the sensor condition associated with a message is satisfied for at least a predetermined time, the apparatus may notify the sender of the message or disclose the message to a third party, who can advise the message recipient or help the message recipient take appropriate action. When a newly received message supercedes an older received message with a similar sensor condition, the apparatus may notify the sender of the older message, so that the sender can cancel the message.

### BACKGROUND OF THE INVENTION

1. Field of the Invention

The present invention relates to message management apparatus that stores messages such as electronic mail together with sensor conditions attached to the-messages, and uses the sensor conditions to manage the messages.

2. Description of the Related Art

As unread-electronic mail accumulates, message management places an increasing burden on the parties concerned. Among the various schemes proposed for reducing this burden, Japanese Unexamined Patent Application Publication No. H10-308770, for example, describes a message management apparatus that urges the senders of unread mail to cancel unimportant pieces of unread mail when the number of pieces of unread mail reaches a predetermined limit, or when the time for which the mail has remained unread reaches a predetermined limit. Also described is an apparatus that automatically cancels unread mail at a designated time on a designated date specified in information attached to the mail when it is sent.

Messages sent to elderly people traveling on journeys or dwelling in distant locations not infrequently include words of advice or concern, such as, ‘Be sure to wear your coat if it gets cold.’ This message can be left unread as long as the weather is not cold, but should be saved for the day when cold weather sets in. Conversely, if the weather is already cold, the message needs to be read promptly and should not be left unread. These requirements are not met by conventional apparatus that operates according to the number of pieces of unread mail or the time for which the mail has remained unread.

Moreover, what the sender of a message needs to know is not whether a message has been read before being canceled according to a predetermined condition, but whether the message has been read and acted on at the appropriate time. Simply setting a cancellation date and time as in the conventional apparatus described above does not meet this requirement.

The cancellation condition could be tied to a quantity that rises and falls, such as the message recipient's body temperature, instead of a quantity that progresses monotonically like clock time, but then further problems have been found to occur: if the quantity falls outside the necessary range for even a brief instant, mail that should be saved may be canceled, or mail that should be canceled may be left to clutter the recipient's electronic mailbox.

For these reasons, conventional apparatus cannot be said to make the most effective use of messages.

### SUMMARY OF THE INVENTION

An object of the present invention is to provide a message management apparatus that can improve the efficiency with which messages are used.

The invention provides message management apparatus having a message storage unit for storing messages, sensor conditions, and if necessary, source information. A message input unit receives messages and stores the messages, together with associated sensor conditions and, if necessary, source information, in the message storage unit. A message reading unit displays the messages stored in the message storage unit according to the associated sensor conditions and according to sensor values obtained from a set of sensors, thereby enabling a person to select and read the currently relevant messages.

According to one aspect of the invention, a sensor condition tester determines whether the data received from the sensors satisfy the sensor conditions associated with the messages stored in the message storage unit. For a message for which this is the case, a duration tester decides whether the sensor condition associated with the message has been satisfied for at least a predetermined time. If that is also the case, a notifier uses the source information associated with the message to identify the sender of the message, and notifies the sender that, for example, the message remains unread under a condition in which it should be read, or that the condition persists even though the message has been read. The message sender can then take appropriate action, such as contacting the message recipient by telephone.

According to another aspect of the invention, if the sensor condition tester and duration tester determine that the sensor condition associated with a message has been satisfied for a predetermined time, a discloser discloses the message to a third party different from the sender and recipient of the message, so that the third party can assist the message recipient in taking appropriate action on the basis of the message.

According to yet another aspect of the invention, a condition searcher compares the sensor conditions associated with messages stored in the message storage unit with the sensor conditions associated with messages newly received by the message input unit to find stored messages having sensor conditions similar to the sensor conditions associated with the newly received messages. A notifier uses the source information associated with these stored messages to identify the senders of the stored messages, and notifies the senders, so that they can cancel stored messages that have been superceded by newly received messages.

### BRIEF DESCRIPTION OF THE DRAWINGS

In the attached drawings:

FIG. 1 is a block diagram of a message management system in a first embodiment of the invention;

FIGS. 2A and 2B show exemplary input messages;

FIG. 3 shows exemplary progressions of values indicated by sensors;

FIG. 4 is a block diagram of a message management system in a second embodiment of the invention;

FIG. 5 is a block diagram of a message management system in a third embodiment of the invention;

FIG. 6 shows an exemplary disclosure destination information schedule;

FIG. 7 is a block diagram of a message management system in a fourth embodiment of the invention;

FIG. 8 shows exemplary messages stored in the message storage unit in FIG. 7;

FIG. 9 shows a Japanese version of the message in FIG. 2A; and

FIG. 10 shows Japanese versions of the messages in FIG. 8.

### DETAILED DESCRIPTION OF THE INVENTION

Embodiments of the invention will now be described with reference to the attached drawings, in which similar elements are indicated by similar reference characters.

### First Embodiment

The first embodiment described below is a message management apparatus that prioritizes messages for display under specified environmental conditions, and notifies the source (sender) of a message if the message remains unread under these environmental conditions.

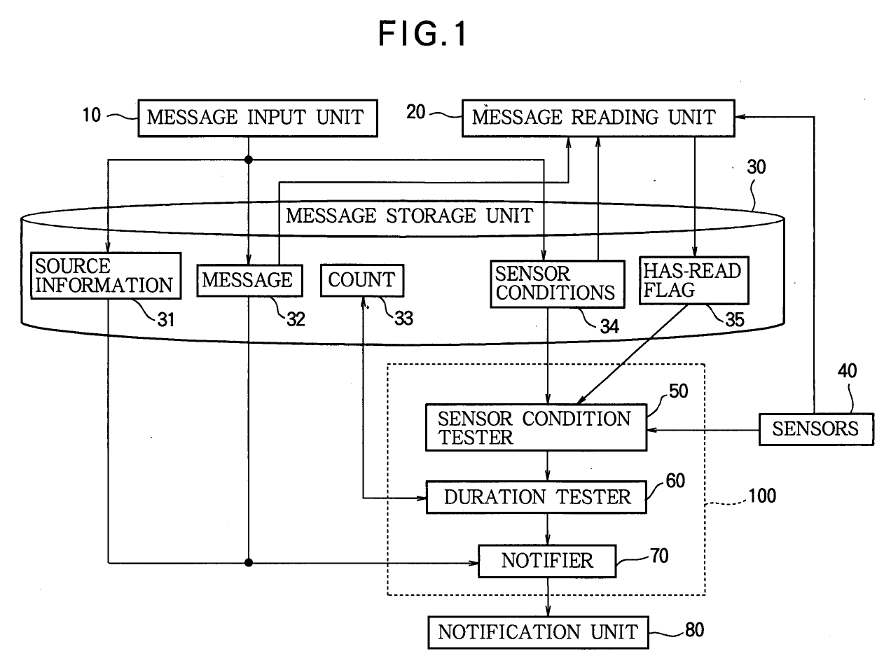

Referring to the block diagram in FIG. 1, the message management apparatus in the first embodiment comprises a message input unit 10, a message reading unit 20, a message storage unit 30, a set of sensors 40, a sensor condition tester 50, a duration tester 60, a notifier 70, and a notification unit 80. The sensor condition tester 50, duration tester 60, and notifier 70 constitute a message processing unit 100.

The message input unit 10 sets sensor conditions that obtain under environmental conditions in which a message should be displayed with priority by the message reading unit 20, stores the message 32 in the message storage unit 30 together with the set sensor conditions 34 and source information 31 specifying how to contact the person who sent the message, initializes a count 33 associated with the message, and initializes a has-read flag 35 associated with the message to indicate the unread condition. Sensor conditions can be set by extracting data written in a specific format in the message, or by any other method of associating sensor conditions with a message. For example, if a message is input through the worldwide web facility of the Internet, an entry form may be displayed on which the message sender can specify the sensor conditions directly. Similarly, if the message is input by electronic mail, the address entered in the ‘From:’ field of the electronic mail form can be used as the source information.

The message reading unit 20 compares the sensor conditions stored together with the messages in the message storage unit 30 to values sensed by the sensors 40, and urges the user to read the messages that need to be read in the present environmental conditions, as indicated by the sensor conditions and sensor values, thereby encouraging the message recipient to read the messages efficiently. Any suitable method of urging can be used: for example, messages having sensor conditions that are satisfied by the values sensed by the sensors 40 can be displayed at the top of a list of stored messages. When the user has read a message in the message reading unit 20, the message reading unit 20 sets the has-read flag 35 associated with the message in the message storage unit 30 to indicate the read condition.

The message storage unit 30 stores the messages 32 received from the message input unit 10, the source information 31 associated with the messages, and the sensor conditions 34, together with the has-read flags 35 and counts 33.

The set of sensors 40 includes one or more sensors that sense the user's environmental conditions. Examples of such sensors include a body temperature sensor or clinical thermometer, a blood pressure gauge or sphygmomanometer, an atmospheric temperature sensor or atmospheric thermometer, and a perambulation sensor or pedometer.

The sensor condition tester 50 is a module in the message processing unit 100 that is executed at predetermined times, such as at regular intervals measured by a timer. Among the messages stored in the message storage unit 30, the sensor condition tester 50 processes messages having has-read flags 35 indicating the unread condition by comparing the sensor conditions associated with these messages to the (newest) values sensed by the sensors 40. For messages with sensor conditions that are satisfied by the values, the sensor condition tester 50 invokes the duration tester 60.

The duration tester 60 is a module in the message processing unit 100 that increments the count 33 stored in the message storage unit 30 for each message for which the duration tester 60 is invoked by the sensor condition tester 50. The duration tester 60 then decides whether the incremented count has reached at least a predetermined value. If, for example, the sensor condition tester 50 is executed once every ten minutes, and the sender of a message is to be notified if the sensor condition or conditions associated with the message remain true for at least an hour, then the predetermined value is six (1 hour/10 minutes=6). If the duration tester 60 finds that the count is equal to or greater than the predetermined value (e.g., 6);, the duration tester 60 invokes the notifier 70 and initializes the count 33. Initializing the count prevents repeated execution of the notifier 70 and repeated sending of notifications to the message sender at, for example, ten-minute intervals. If the sensor conditions are still satisfied when the count reaches the predetermined value again after, for example, another hour, however, the sender will be notified again at the end of that one-hour interval. Further restrictions can also be set: for example, only one notification per message, or a limited number of notifications per message.

The notifier 70 is another module in the message processing unit 100. When the duration tester 60 decides that a message 32 has a count 33 equal to or greater than the predetermined value (indicating that the message's sensor conditions have been satisfied for at least the predetermined time), the notifier 70 uses the notification unit 80 and the source information stored in the message storage unit 30 to notify the sender of the message that the message is unread. The notification issued by the notifier 70 includes the title of the message, an identifier, and part or all of the message text, so that the sender can determine which message is being reported as unread.

If the message input unit 10 is a means for receiving electronic mail (an electronic mail reader) and the source information in the message storage unit 30 is the address of the sender of the electronic mail, the notification unit 80 is a means for sending electronic mail to the address given by the source information to report that the message is unread (an electronic mail transmitter).

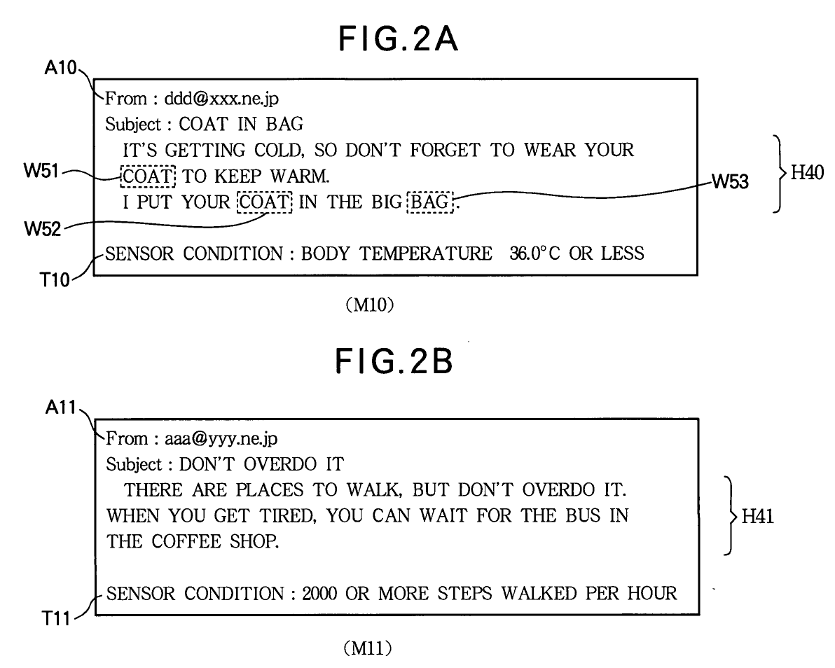

The operation of the first embodiment in the configuration described above will be further explained below. In FIGS. 2A and 2B, two examples of electronic mail input to the message input unit 10 are shown. In the first embodiment, sensor types and sensor condition values are entered in a predetermined format in the lines T10 and T11 starting with ‘Sensor condition:’. The message input unit 10 detects lines starting with ‘Sensor condition:’ in pieces of electronic mail, and stores the sensor conditions in the message storage unit 30. Since the electronic mail address (e-mail address) of the sender is entered in the line starting with ‘From:’ in general electronic mail systems, the e-mail address is used as the source information. Accordingly, when electronic mail M10 is stored as a message, ‘ddd@xxx.ne.jp’ in line A10 and ‘body temperature 36.0° C. or less’ in line T10 are stored as the source information and the sensor condition in the message storage unit 30. Similarly, when electronic mail M11 is stored as a message, ‘aaa@yyy.ne.jp’ in line A11 and ‘2000 or more steps walked per hour’ in line T11 are stored as the source information and the sensor condition in the message storage unit 30.

The message reading unit 20 compares the sensor conditions with the values sensed by the set of sensors 40, including the recipient's body temperature and the pedometer reading, and provides an interface that enables the recipient of the electronic mail to efficiently find and view the electronic mail that currently needs to be read. More specifically, the sensor conditions described above indicate the conditions under which the recipient should view the messages in the message reading unit 20.

In the description of the operation of the first embodiment below, the two pieces of electronic mail M10 and M11 have been input to the message input unit 10 at substantially the same time, and have been stored in the message storage unit 30 in the operation described above, but the recipient has not yet used the message reading unit 20 to read these messages. Accordingly, the has-read flags associated with the messages (electronic mail M10 and M11) indicate the unread condition.

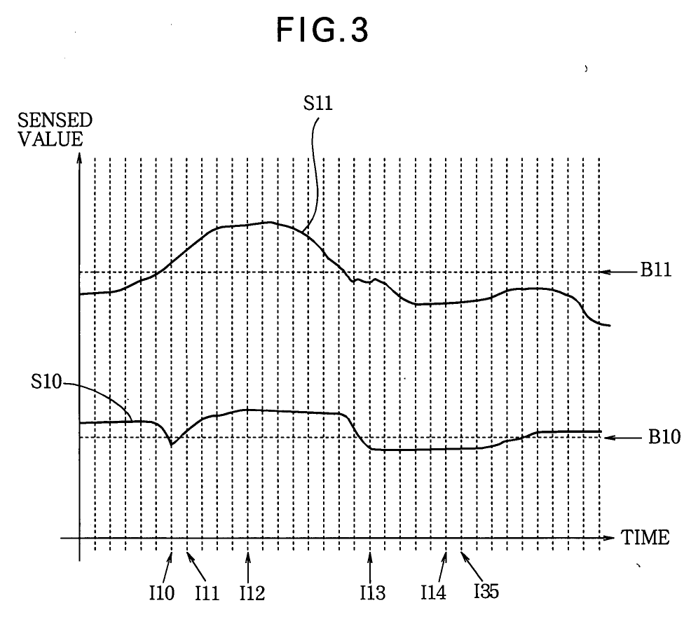

In FIG. 3, two examples of the progression of values indicated by the sensors 40 are shown, starting from the time of reception of electronic mail M10 and M11. Curve S10 indicates the recipient's body temperature; curve S11 indicates the number of steps walked per hour. Horizontal dashed line B10 indicates 36.0° C.; horizontal dashed line B11 indicates 2000 steps/hour. Lines B10 and B11 indicate the threshold values of the sensor conditions associated with electronic mail M10 and M11. The vertical dashed lines indicate timings at which the sensor condition tester 50 is executed. If the sensor condition tester 50 is executed once every ten minutes, for example, the vertical dashed lines indicate ten-minute intervals.

At time I10, since the has-read flag associated with electronic mail M10 indicates the unread condition, the sensor condition tester 50 determines whether the sensor condition associated with electronic mail M10 is satisfied by the value sensed by the body temperature sensor. The body temperature value returned from the set of sensors 40 is 36.0° C., which is lower than the threshold value B10. Since the sensor condition is satisfied, the sensor condition tester 50 invokes the duration tester 60 for electronic mail M10. Since the has-read flag associated with electronic mail M11 also indicates the unread condition, and the value indicated by the pedometer exceeds the threshold value B11, which is 2000 steps/hour, the sensor condition associated with electronic mail M11 is similarly satisfied, and the sensor condition tester 50 also invokes the duration tester 60 for electronic mail M11.

The duration tester 60 is thus invoked for electronic mail M10 and M11 at time I10. The duration tester 60 increases the counts C10 and C11 associated with electronic mail M10 and M11 from their initial values of zero to one (C10=1 and C11=1). If the duration tester 60 finds that the count is equal to or greater than six (indicating that the sensor condition associated with the electronic mail has been satisfied for at least an hour), the duration tester 60 invokes the notifier 70. Since counts C10 and C11 are less than six, the duration tester 60 does not invoke the notifier 70, and the processing at time I10 ends without further action being taken.

At time I11, since the message recipient's body temperature is higher than the threshold value B10, the sensor condition tester 50 does not invoke the duration tester 60 for electronic mail M10; since the value sensed by the pedometer exceeds the threshold value B11 as at time I10, the sensor condition associated with electronic mail M11 is satisfied, and the sensor condition tester 50 invokes the duration tester 60 for electronic mail M11.

Accordingly, the duration tester 60 is invoked only for electronic mail M11 at time I11. As a result, the count C11 associated with electronic mail M11 increases from one to two (C11=2). Since the duration tester 60 is not invoked for electronic mail M10, its count C10 remains one (C10=1). Since counts C10 and C11 are less than six, the duration tester 60 does not invoke the notifier 70, and the processing at time I11 ends without further action being taken.

From time I11 until just before time I12, the sensor condition associated with the message M11 continues to be satisfied while the sensor condition associated with message M10 continues not to be satisfied, so during this interval the same processing is executed as at time I11. The processing at time I12 starts under conditions in which the counts C10 and C11 associated with electronic mail M10 and M11 are one and five, respectively.

At time I12, since the message recipient's body temperature is still higher than the threshold value B10, the sensor condition tester 50 does not invoke the duration tester 60 for electronic mail M10; since the value sensed by the pedometer exceeds the threshold value B11 as at time I10, the sensor condition associated with electronic mail M11 is satisfied, and the sensor condition tester 50 invokes the duration tester 60 for electronic mail M11.

Accordingly, the duration tester 60 is invoked only for electronic mail M11 at time I12. As a result, the count C11 associated with electronic mail M11 increases from five to six (C11=6). Since the duration tester 60 is not invoked for electronic mail M10, its count C10 remains one (C10=1). Since count C11 is equal to six, the duration tester 60 invokes the notifier 70 for electronic mail M11 and initializes count C11 to zero.

When the notifier 70 is invoked for electronic mail M11 at time I12 as described above, the notification unit 80, which is a means for sending electronic mail, notifies the sender of electronic mail M11 that electronic mail M11 is unread by sending electronic mail to the sender's e-mail address, ‘aaa@yyy.ne.jp’ in line A11 in FIG. 2A. The message body of the electronic mail includes, for example, the subject line ‘Don't overdo it’ of electronic mail M11, and states that the recipient has not yet read the ‘Don't overdo it’ message.

From time I12 to time I13 the sensor condition associated with electronic mail M10 is not satisfied, so count C10 remains one up to time I13.

At time I13, the value sensed by the body temperature sensor is below the threshold value B10, so the sensor condition associated with electronic mail M10 is satisfied.

The duration tester 60 is accordingly invoked for electronic mail M10, and the count C10 associated with electronic mail M10 increases from one to two, but since count C10 is less than six, the duration tester 60 does not invoke the notifier 70, and the processing for electronic mail M10 at time I13 ends without further action being taken.

From time I13 to the time immediately before time I14, the same processing is executed as at time I13. When the sensor condition tester 50 is invoked at time I14, count C10 has reached five. The message recipient's body temperature is still below the threshold value B10, satisfying the sensor condition associated with electronic mail M10, so the duration tester 60 is invoked for electronic mail M10.

When the duration tester 60 is invoked for electronic mail M10 at time I14, it increments the count C10 associated with electronic mail M10 from five to six, which is the predetermined value at which the duration tester 60 invokes the notifier 70. The duration tester 60 also initializes count C10 to zero.

When the notifier 70 is invoked for electronic mail M10 at time I14, as for electronic mail M11 at time I12, the notification unit 80 notifies the sender of electronic mail M11 that electronic mail M11 is unread by sending electronic mail to the sender's e-mail address, ‘ddd@xxx.ne.jp’. The message body of the electronic mail states that the recipient has not yet read the message with the ‘coat in bag’ subject line.

According to the operation described above, although the message input unit 10 receives electronic mail M10 and M11 at substantially the same time and both pieces of mail are left unread, the sender of electronic mail M10 is not notified that his or her mail has not yet been read until time I14, when the recipient's body temperature has been lower than the predetermined value for a predetermined interval; the sender of electronic mail M11 is notified that his or her mail has not yet been read at time I12, when the recipient has walked more than a predetermined number of steps for a predetermined interval.

According to the first embodiment described above, the sender of a message is notified if the message remains unread for a certain amount of time in conditions under which it should be read or acted on, regardless of how long the message may have been left unread under conditions in which it does not need to be read or acted on. When notified, the sender can contact the recipient by telephone or some other means to give the necessary information or advice. The first embodiment relieves the sender from worry about whether a necessary message has been read or not, so that the sender will not make unnecessary telephone calls to the recipient. Nor will the sender make unnecessary telephone calls when the condition under which the message needs to be read persists for only a brief interval. The first embodiment accordingly improves the efficiency of electronic mail communication for the sender of the mail. The first embodiment also improves the efficiency of communication for the recipient, since the recipient does not receive unnecessary telephone calls inquiring about possibly unread mail, but does receive reminders when the reminders are needed.

### Second Embodiment

The second embodiment described below is a message management apparatus that displays a message with priority under a prescribed condition, and notifies the source (sender) of the message if the condition persists for more than a predetermined interval, even though the message has already been read. Typically, the sender is notified if a specified condition worsens and stays worse for more than a certain period of time.

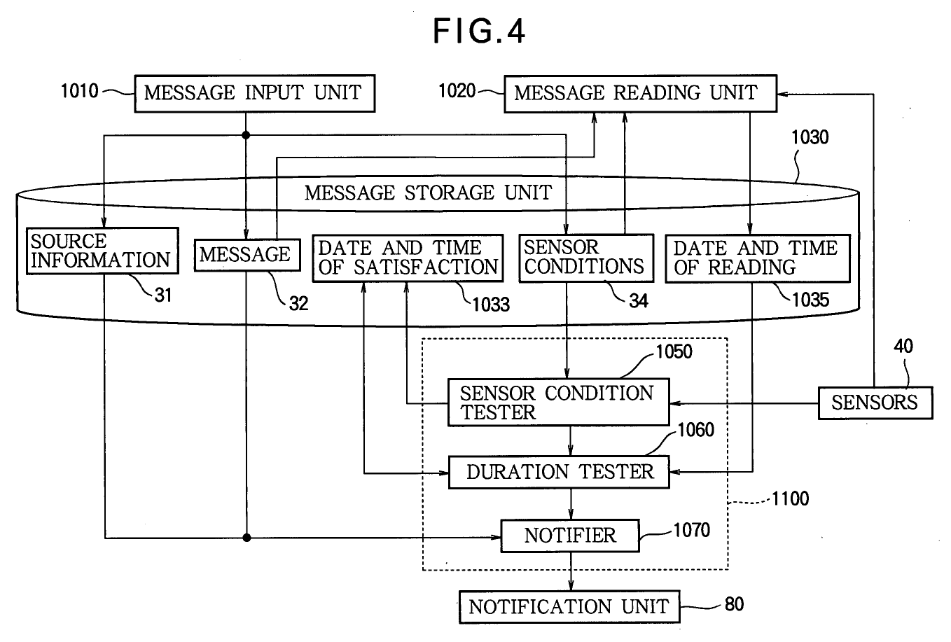

Referring to the block diagram in FIG. 4, the message management apparatus in the second embodiment comprises a message input unit 1010, a message reading unit 1020, a message storage unit 1030, a set of sensors 40, a sensor condition tester 1050, a duration tester 1060, a notifier 1070, and a notification unit 80. The sensor condition tester 1050, duration tester 1060, and notifier 1070 constitute a message processing unit 1100.

The message storage unit 1030 stores messages 32, source information 31, and sensor conditions 34 associated with the messages as in the first embodiment, date and time of reading information 1035 that indicates the date and time at which each message was last viewed, and date and time of satisfaction information 1033 that indicates the date and time at which the sensor value associated with message last changed from a value not satisfying the sensor condition to a value satisfying the sensor condition, provided the sensor condition is still satisfied.

The message input unit 1010 stores the messages 32 in the message storage unit 1030 together with the source information 31 and sensor conditions 34 associated with the messages as in the first embodiment, and initializes the date and time of reading 1035 and the date and time of satisfaction 1033. More specifically, the message input unit 1010 initializes the date and time of reading and the date and time of satisfaction to a null state in which no date or time is set.

The message reading unit 1020 compares the sensor conditions stored together with the messages in the message storage unit 1030 to values sensed by the sensors 40, and urges the message recipient to read the messages that need to be read in the present environmental conditions, as indicated by the sensor conditions and sensor values, thereby encouraging the recipient to read the messages efficiently. Any suitable method of urging can be used, as in the first embodiment: for example, messages having sensor conditions that are satisfied by the values sensed by the sensors 40 can be displayed at the top of a list of stored messages, or the recipient may be notified that the messages are present. When the recipient has read a message presented by the message reading unit 1020, the message reading unit 1020 updates the date and time of reading associated with the message in the message storage unit 1030 to indicate the date and time at which the recipient read the message.

The sensor condition tester 1050 is a processing module that is executed at predetermined times, such as at regular intervals measured by a timer. In the description below it will be assumed that the sensor condition tester is executed at ten-minute intervals. The sensor condition tester 1050 processes the messages stored in the message storage unit 1030, and compares the sensor conditions associated with these messages to the (newest) values sensed by the sensors 40. If a message has a sensor condition not satisfied by the corresponding sensor value, the sensor condition tester 1050 initializes the date and time of satisfaction of the messages stored in the message storage unit 1030; for messages with sensor conditions that are satisfied by the sensor values, the sensor condition tester 1050 invokes the duration tester 1060.

The duration tester 1060 is another processing module. For each message for which the duration tester 1060 is invoked by the sensor condition tester 1050, the duration tester 1060 decides whether the sensor conditions associated with the message have been satisfied for at least a predetermined continuous interval and the message has been read within another predetermined interval. To make this decision, the duration tester 1060 starts by calculating the time elapsed since the date and time of satisfaction 1033 stored in the message storage unit 1030 for the message. If the date and time of satisfaction is in the initial null state, the duration tester 1060 updates the date and time of satisfaction to the present date and time. The duration tester 1060 also calculates how much time has elapsed since the date and time of reading 1035 stored in the message storage unit 1030 for the message. If the duration tester 1060 finds that the elapsed time from date and time of satisfaction is equal to or greater than a first predetermined value, assumed to be equal to 50 minutes in the following description, and the elapsed time from the date and time of reading is within a second predetermined value, assumed to be one and a half hours in the following description, the duration tester 1060 invokes the notifier 1070 and initializes the date and time of satisfaction. Initializing the date and time of satisfaction prevents repeated execution of the notifier 1070 and the sending of identical notifications to the message sender at ten-minute intervals; the next notification will not be sent for at least another fifty minutes. Further restrictions can also be set: for example, the notifications may be counted and an upper limit set on the number of notifications per message.

The notifier 1070 is a processing module generally similar to the notifier in the first embodiment. For each message for which the notifier 1070 is invoked by the duration tester 1060, however, the notifier 1070 uses the notification unit 80 and the source information stored in the message storage unit 1030 to inform the sender of the message that the sensor values have not improved for a predetermined interval even though the message has been read. The notification issued by the notifier 70 includes the title of the message, an identifier, and part or all of the message text, so that the sender can determine which message is being reported on. The notification may also include other information such as the elapsed time calculated by the duration tester 1060.

The operation of the second embodiment in the configuration described above will be explained below, with reference to the same examples, shown in FIGS. 2A, 2B, and 3, as in the first embodiment. For electronic mail M10 in FIG. 2A, the message input unit 1010 extracts ‘ddd@xxx.ne.jp’ as the source information and ‘body temperature 36.0° C. or less’ as the sensor condition, stores the extracted source information and sensor condition in the message storage unit 1030 as in the first embodiment, and initializes the associated date and time of reading and the date and time of satisfaction. Similarly, for electronic mail M11, the message input unit 1010 extracts ‘aaa@yyy.ne.jp’ as the source information and ‘2000 or more steps walked per hour’ as the sensor condition, stores the extracted source information and sensor condition in the message storage unit 1030, and initializes the associated date and time of reading and the date and time of satisfaction.

Although the message reading unit 1020 displays messages and enables the user to read the messages in the same way as the message reading unit 20 in the first embodiment, when the recipient has read a message in the message reading unit 1020, the message reading unit 1020 updates the date and time of reading associated with the message and stored in the message storage unit 1030 to indicate the present date and time.

The message input unit 1010 stores electronic mail messages M10 and M11 and their associated information in the message storage unit 1030 before time I10 in FIG. 3. Until time I10, the sensor conditions associated with electronic mail messages M10 and M11 remain unsatisfied, so the dates and times of satisfaction associated with electronic mail M10 and M11 remain in the initial null state.

At time I10 in FIG. 3, the body temperature value on curve S10 goes below the threshold value B10 of 36.0° C. The sensed value now satisfies the sensor condition associated with message M10 ‘body temperature 36.0° C. or less’ that is stored in the message storage unit 1030 as a condition in which the message reading unit 1020 should display message M10. Accordingly, the message reading unit 1020 displays message M10 so as to urge the recipient to read this message with priority. Similarly, since the sensor condition associated with message M11 ‘2000 or more steps walked per hour’, is now satisfied, the message reading unit 1020 displays message M11 so as to urge the recipient to read it with priority. If the recipient reads messages M10 and M11 at time I10, the message reading unit 1020 updates the dates and times of reading associated with messages M10 and M11 and stored in the message storage unit 1030 to indicate time I10.

The sensor condition tester 1050 that is executed at timings indicated by the vertical dashed lines in FIG. 3 is executed at time I10. For message M10, since the sensor condition is satisfied as described above, the duration tester 1060 is invoked. For message M11, since the value (on curve S11) indicated by the pedometer exceeds the threshold value B11, which is 2000 steps/hour, the sensor condition associated with message M11 ‘2000 or more steps walked per hour’ is similarly satisfied, so the sensor condition tester 1050 also invokes the duration tester 1060. Accordingly, the duration tester 1060 is invoked for both messages M10 and M11.

Since the date and time of satisfaction associated with message M10 is in the initialized state, the duration tester 1060 updates the date and time of satisfaction to the present date and time I10. The elapsed time from the date and time of satisfaction then becomes zero, which is less than the predetermined value (50 minutes), so the processing of message M10 at time I10 ends without further action being taken. Similarly, for message M11, the date and time of satisfaction associated with message M11 is updated, the elapsed time from the date and time of satisfaction becomes zero, and the processing of message M11 at time I10 ends without further action being taken.

When the processing of messages M10 and M11 at time I10 ends, the dates and times of satisfaction and dates and times of reading of messages M10 and M11 both indicate time I10.

Next, at time I11, the sensor condition tester 1050 finds that the value sensed by the body temperature sensor exceeds the threshold value B10 and thus does not satisfy the sensor condition associated with message M10. Accordingly, the sensor condition tester 1050 initializes the date and time of satisfaction associated with message M10, and the processing of message M10 at time I11 ends without further action being taken. Since the value sensed by the pedometer still exceeds the threshold value B11, however, the sensor condition tester 1050 invokes the duration tester 1060 for message M11.

The duration tester 1060 calculates the elapsed time since the date and time of satisfaction associated with message M11. Since this date and time of satisfaction remains I10, the elapsed time is ten minutes (the time interval between dashed lines in FIG. 3). This is less than the predetermined value (50 minutes), so the processing at time I11 ends without further action being taken. Since the date and time of satisfaction is not the null value, the date and time of satisfaction is not updated to time I11.

The same processing as at time I11 is now executed at ten-minute intervals until just before time I12. Since the sensor condition associated with message M10 is not satisfied, the date and time of satisfaction associated with message M10 remains at the null value; since the sensor condition associated with the message M11 remains satisfied, the date and time of satisfaction associated with message M11 remains I10.

At time I12, since the sensor condition associated with message M10 is not satisfied, the sensor condition tester 1050 does not invoke the duration tester 1060 for message M10; since the value sensed by the pedometer exceeds the threshold value B11 in FIG. 3, satisfying the sensor condition associated with message M11, the sensor condition tester 1050 invokes the duration tester 1060 for message M11.

The duration tester 1060 finds that the date and time of satisfaction associated with message M11 is I10, so at time I12 the elapsed time is fifty minutes, which is equal to the predetermined value (50 minutes). The date and time of reading associated with message M11 is also I10, and the elapsed time from the date and time of reading is also fifty minutes, which is within the necessary value (one and a half hours). The duration tester 1060 initializes the date and time of satisfaction associated with message M11, and the duration tester 1060 invokes the notifier 1070 for message M11.

When the notifier 1070 is invoked for message M11, the notification unit 80, which is a means for sending electronic mail, notifies the sender of message M11 that the recipient's condition has not improved even though message M11 has been read, by sending electronic mail to the sender's e-mail address, ‘aaa@yyy.ne.jp’ in line A11. The message body of the electronic mail includes, for example, the subject line ‘Subject: Don't overdo it’ of message M11, and states that the recipient's condition has not improved even though the ‘Don't overdo it’ message has been read.

In the operation described above, the message recipient's body temperature goes below the threshold value B10 of message M10 at time I10, so the message reading unit 1020 urges the recipient to read message M10. The recipient does so, puts on the requested coat, and experiences a return to normal body temperature at time I11. There is no need to notify the sender of message M10 of this, and no notification is sent. Also at time I10, the value indicated by the message recipient's pedometer goes above threshold value B11, satisfying the sensor condition of message M11. The recipient reads message M11, but fails to act on it, and the pedometer value remains higher than the threshold value B11 during the interval from time I10 to time I12. The sender of message M11 is notified at time I12.

Accordingly, the sender of, for example, a message explaining what to do when the recipient's body temperature falls is not notified of a brief fall in the recipient's body temperature followed by a quick return to a normal temperature; the sender of a message explaining what to do if the recipient walks too much, however, is notified if the recipient has read the message but persists in walking too much anyway. When the sender is notified that the recipient's condition has not improved even though the message has been read, the sender can contact the recipient directly by telephone to give information or advice. The second embodiment accordingly improves the efficiency of electronic mail communication for the sender of the message, because if the sender is not notified, the sender will know that the message has not been read and ignored.

Although the second embodiment described above is configured to provide warning when the recipient of a message reads the message but ignores it, the sender may want to be notified of the recipient's condition regardless of whether the message has been read. In that case, the second embodiment may be modified so that the duration tester 1060 does not include the date and time of reading in its decision process.

### Third Embodiment

Whereas the second embodiment described above notifies the sender of a message, the third embodiment shows the message to a third party, or makes it possible for the third party to read the message, thereby enabling the third party to help improve the message recipient's condition.

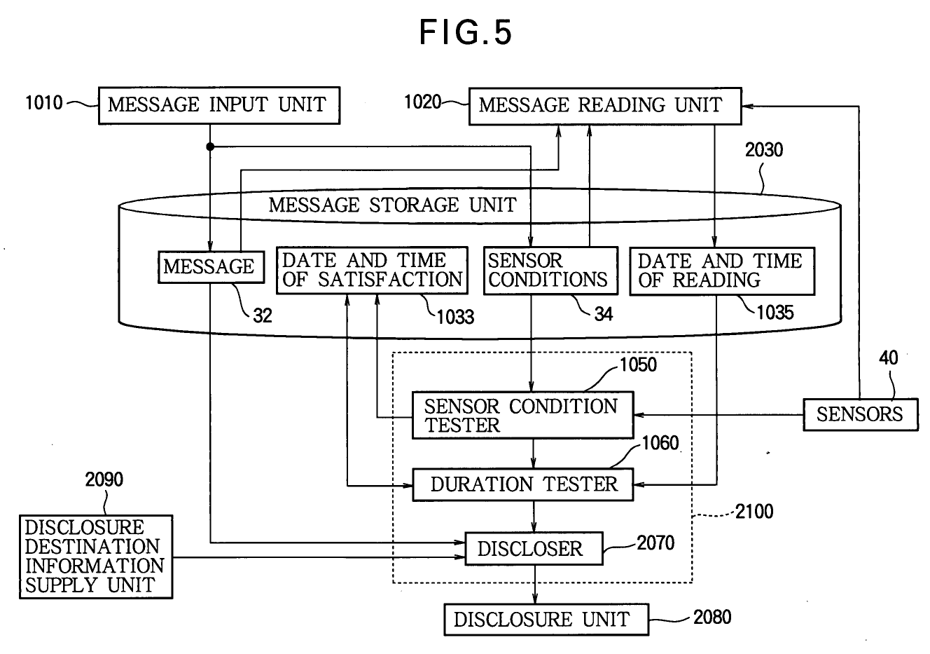

Referring to the block diagram in FIG. 5, the message management apparatus in the third embodiment comprises a message input unit 1010, a message reading unit 1020, a message storage unit 2030, a set of sensors 40, a sensor condition tester 1050, a duration tester 1060, a discloser 2070, a disclosure unit 2080, and a disclosure destination information supply unit 2090. The sensor condition tester 1050, duration tester 1060, and discloser 2070 constitute a message processing unit 2100. The message input unit 1010, message reading unit 1020, set of sensors 40, sensor condition tester 1050, and duration tester 1060 are as described in the second embodiment (FIG. 4), except that the duration tester 1060 invokes the discloser 2070, instead of a notifier, when it decides that the sensor conditions associated with a message have been satisfied for at least a first predetermined interval and the message has been viewed within a second predetermined interval.

The message storage unit 2030 stores messages 32, sensor conditions 34, dates and times of satisfaction 1033, and dates and times of reading 1035, but differs from the message storage unit in the second embodiment (FIG. 4) by not storing source information.

The discloser 2070 is a module in the message processing unit 2100 that discloses the message for which it is invoked to a third party other than the sender and recipient of the message, or enables the third party to read the message. The discloser 2070 may disclose a message to the third party by, for example, sending the message as electronic mail to a disclosure destination mail address supplied by the disclosure destination information supply unit 2090. If the message input unit 1010 encrypts messages and stores the encrypted messages in the message storage unit 2030, and the recipient is the only one who can decode the encrypted messages (the third party cannot decode them), the discloser 2070 may decode each message for which it is invoked, and store the decoded message again in the message storage unit 2030 so that the third party can read the decoded message by using the message reading unit 1020, or disclose the decoded message by sending it as electronic mail to the third party.

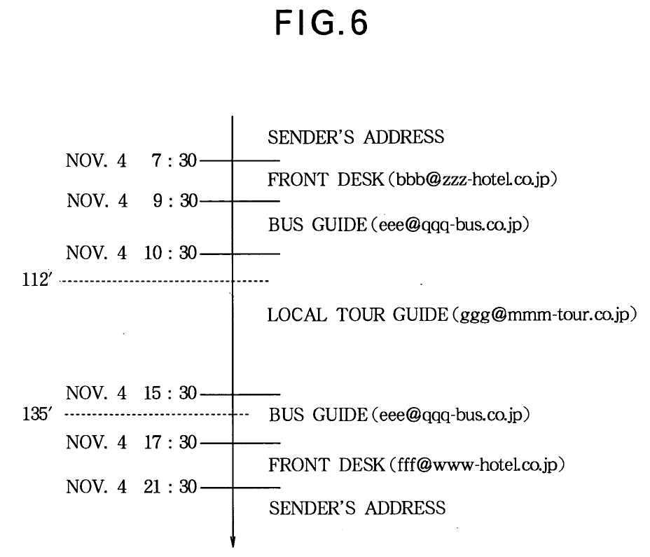

The disclosure destination information supply unit 2090 supplies disclosure destination information to the discloser 2070. The disclosure destination information identifies the third party to whom the discloser 2070 should disclose a message. If the message is disclosed to the third party by sending electronic mail, the disclosure destination information is the e-mail address of the third party. The disclosure destination information supply unit 2090 may have a schedule of specific addresses that are active during specific periods of time. The disclosure destination information supply unit 2090 outputs the address that is active when the discloser 2070 accesses the disclosure destination information supply unit 2090 (that is, when the discloser 2070 is invoked). The active address may change from day to day and time to time as shown in FIG. 6, for example. The disclosure destination addresses and their schedule may be prestored in the message storage unit 2030 or in another memory device. The mail addresses may be entered through the message input unit 1010. Different third-party mail addresses may be set as disclosure destination information for each message, stored in the message storage unit 2030, and output as necessary when the discloser 2070 is invoked.

The disclosure unit 2080 is a means for actually disclosing messages. If a message is sent to the third party by sending electronic mail, the disclosure unit 2080 is a means for sending (transmitting) electronic mail. If encrypted messages in the message storage unit 2030 are decoded, the disclosure unit 2080 includes decoding means.

The operation of the third embodiment will be described below. From message input up to the processing carried out by the 1060, the third embodiment operates in the same way as the second embodiment. The duration tester 1060 invokes the discloser 2070, instead of a notifier, when it decides that the sensor conditions associated with a message have been satisfied for at least a predetermined interval and the message has been viewed within another predetermined interval. At timing I12 in FIG. 3, the discloser 2070 is invoked for message M11 in FIG. 2B.

It will be assumed below that the processing described in the second embodiment continues after time I12, and that as a result, the duration tester 1060 invokes the discloser 2070 for message M10 at time I35 in FIG. 3.

It will also be assumed that the disclosure destination information supply unit 2090 operates according to the schedule shown in FIG. 6. For example, if the discloser 2070 is invoked at 8:00, November 4, it obtains the mail address ‘bbb@zzz-hotel.co.jp’ of the front desk at a hotel as disclosure destination information. The user (either the message sender or the message recipient) may have prestored these mail addresses as disclosure destination information by using application software of the scheduler type, for example. Alternatively, the user may have, for example, a travel agency supply disclosure destination information according to a tour schedule. Either the user or the travel agency may specify, as disclosure destination information, the mail address of a third party who can help the recipient when the discloser 2070 accesses the disclosure destination information supply unit 2090. For times when no such third party is available, as before 7:30 and after 21:30 in FIG. 6, the message sender's address may be specified.

Time I12 and time I35 in FIG. 3 correspond to time I12′ and time I35′ in FIG. 6, respectively.

At time I12, the discloser 2070 is invoked for message M11 as described above.

The disclosure destination information supply unit 2090 outputs the (active) address ‘ggg@mmm-tour.co.j’ that has been assigned to time I12′, and the discloser 2070 obtains the output address ‘ggg@mmm-tour.co.jp’ as a disclosure destination mail address.

When the discloser 2070 is invoked for message M11, the disclosure unit 2080, which is a means for sending electronic mail, sends the unaltered information content of message M11 in FIG. 2B as electronic mail to mail address ‘ggg@mmm-tour.co.jp’, preferably attaching necessary information so that the third party (a local tour guide, in this case) to whom message M11 is disclosed can help the recipient of message M11. More specifically, the recipient information and the source information (sender's mail address ‘aaa@yyy.ne.jp’) of message M11, and other information may be attached so that the third party can inquire about how to react.

At time I35, when the discloser 2070 is invoked for message M10, the disclosure destination information supply unit 2090 outputs the address ‘eee@qqq-bus.co.jp’ assigned for time I35′ (corresponding to time I35) in FIG. 6. The discloser 2070 sends the content of message M10 as electronic mail to this mail address ‘eee@qqq-bus.co.jp’, in the same way as it sent the content of message M11 (to a different address) at time I12.

As a result of the operation described above, whereas the second embodiment notifies the sender of a message that the recipient's condition has not improved even though the message has been read, the third embodiment uses the disclosure destination information supply unit 2090 and sends the message itself to a specified third party.

According to the third embodiment, when, for example, a sender who is familiar with the recipient has sent message M11 explaining what to do when the recipient walks too much, if the recipient has read the message but persists in walking anyway, message M11 is disclosed to a third party. When message M11 is disclosed to the third party, the third party can advise the recipient as intended by the sender. Message M10 is disclosed to a third party if the condition under which the recipient should wear a coat persists; the third party can promptly find the recipient's coat and help the recipient put it on. The third embodiment improves the efficiency of electronic mail communication for the sender of the message when the recipient of a message is, for example, an elderly person who may not react appropriately to the message, particularly when this may lead to a serious condition. The message then needs to be read by a third party in addition to the elderly recipient, so that the third party can help the recipient according to the information given by the sender.

The third embodiment is configured to disclose a message when the recipient of the message has viewed the message within a predetermined interval as described in the second embodiment; This feature protects the recipient's privacy in that the message is not disclosed to a third party before the recipient has read the message. Nor is the message disclosed so long after the recipient has read the message that the recipient may have forgotten the message. It also gives the recipient a chance to delete the message before the message is revealed to a third party if the recipient does not want the third party to read the message.

Although the third embodiment has been described as a modification of the second embodiment, the first embodiment can be modified similarly. In that case, however, a third party will be shown a message that the recipient of the message has not read.

### Fourth Embodiment

The message reading unit 20 in the first embodiment (FIG. 1) prioritizes messages according to whether their sensor conditions are satisfied, so messages having the same sensor conditions are displayed in the same way. Accordingly, if many messages have the same sensor conditions, the recipient may feel overwhelmed by the large number of messages the message reading unit 20 is urging him or her to read. This is an undesirable situation, especially if many of the messages have similar content; the recipient may also feel that he or she is being nagged.

Therefore, when a message that is newly stored is similar in content and sensor conditions to another message that has already been stored, the fourth embodiment described below notifies the sender of the earlier message, giving the sender an opportunity to cancel the earlier message.

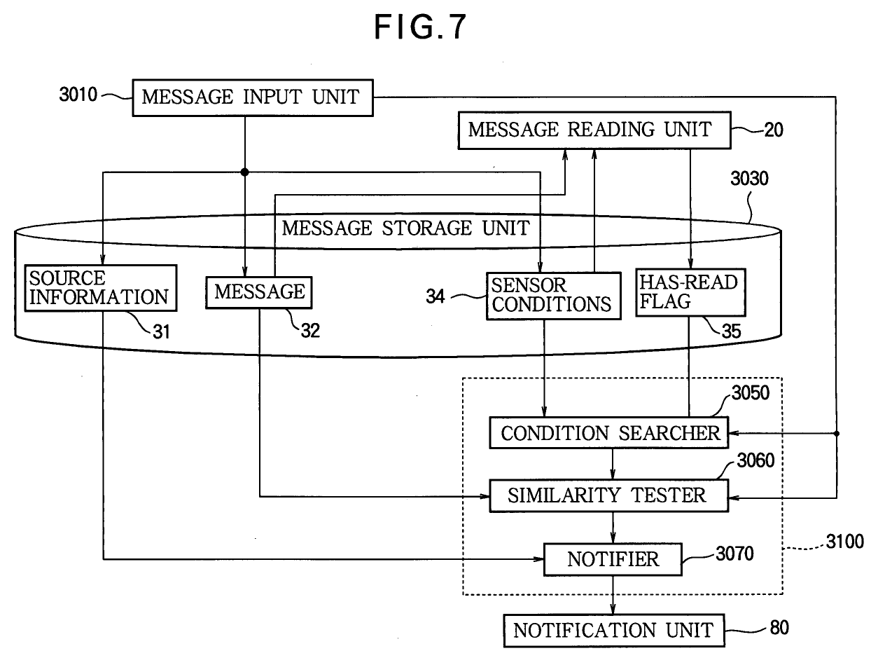

Referring to the block diagram in FIG. 7, the message management apparatus in the fourth embodiment comprises a message input unit 3010, a message reading unit 20, a message storage unit 3030, a condition searcher 3050, a similarity tester 3060, a notifier 3070, and a notification unit 80. The condition searcher 3050, similarity tester 3060, and notifier 3070 constitute a message processing unit 3100. The message reading unit 20 and notification unit 80 are as described in the first embodiment.

The message storage unit 3030 stores source information 31, messages 32, sensor conditions 34, and has-read flags 35, but differs from the message storage unit 30 in the first embodiment (FIG. 1) by not storing counts, which are unnecessary in the fourth embodiment.

When the message input unit 3010 receives an input message, it invokes the condition searcher 3050. Then, like the message input unit 10 in the first embodiment described above (FIG. 1), it stores the message 32 and the associated source information 31 and the sensor conditions 34 in the message storage unit 3030, and initializes a has-read flag 35 associated with the message to indicate the unread condition.

The condition searcher 3050 is a module in the message processing unit 3100 that compares the sensor conditions of a newly input message received by the message input unit 3010 with the sensor conditions of unread messages stored in the message storage unit 3030, using the has-read flag 35 to determine the unread condition. If a previously stored but still unread message and the newly input message have similar sensor conditions, the condition searcher 3050 invokes the similarity tester 3060. Ideally, the condition searcher 3050 should be able to recognize similar sensor conditions even if they are not exactly equal. For example, the sensor conditions ‘body temperature 36.0° C. or less’ and ‘body temperature 36.1° C. or less’ can be treated as similar because both are satisfied by the range of sensor value of 36.0° C. or less. For the sake of simplicity, however, it will be assumed below that the condition searcher 3050 finds only messages having exactly the same sensor conditions.

Incidentally, the reason for invoking the condition searcher 3050 before the newly input message is stored in the message storage unit 3030 is to avoid the extra processing that would otherwise be required to prevent the condition searcher 3050 from comparing the newly input message with itself.

When invoked by the condition searcher 3050 for a message previously stored in the message storage unit 3030, the similarity tester 3060 determines the degree of similarity between the content of the stored message and the content of the message newly input by the message input unit 3010, and invokes the notifier 3070 for the stored message if it finds more than a predetermined number of similarities. Although this process is not essential in the fourth embodiment, it is preferably when there are comparatively few types of sensors and sensor conditions and comparatively many messages, a situation that may cause the condition searcher 3050 to find too many messages with identical sensor conditions. Accordingly, the similarity tester 3060 may be invoked conditionally, when the number of messages that the condition searcher 3050 has found is equal to or greater than a predetermined number.

To determine similarity, the similarity tester 3060 can use any known method of testing similarity of sentences. For example, the similarity tester 3060 may extract words, or words having a specific part of speech such as nouns, from among words obtained by morphological analysis of the message input by the message input unit 3010, search for key character strings, each consisting of one or more consecutively extracted words, in each message for which the similarity tester 3060 is invoked by the condition searcher 3050, and compute the similarity of the message as the number of matching key character strings found. The similarity tester 3060 may decide to invoke the notifier 3070 and thereby notify the sender of the message if, for example, two or more such matching character strings are found.

When invoked by the similarity tester 3060 for a message stored in the message storage unit 3030, the notifier 3070 uses the notification unit 80 and the source information associated with the stored message to inform the sender of the stored message that a newer and similar message has now been input. The notification issued by the notifier 3070 includes the title of the stored message, a message identifier, and part or all of the message text, so that the sender can determine which message is being referred to. The title of the message newly input by the message input unit 3010, part or all of the message text, the source information, and other information are preferably attached, so that the sender can compare the message he or she sent previously with the newly input message.

When the notifier 3070 uses the notification unit 80 to notify the sender of a previous message that a newer message of similar content has been input, it also inquires whether to cancel the previous message. If the sender returns an affirmative reply to this inquiry, the message input unit 3010 deletes the previous message and its associated source information, sensor conditions, and has-read flag from the message storage unit 3030. The method by which this is done may be the same as in the above-mentioned Japanese Unexamined Patent Application Publication No. H10-308770.

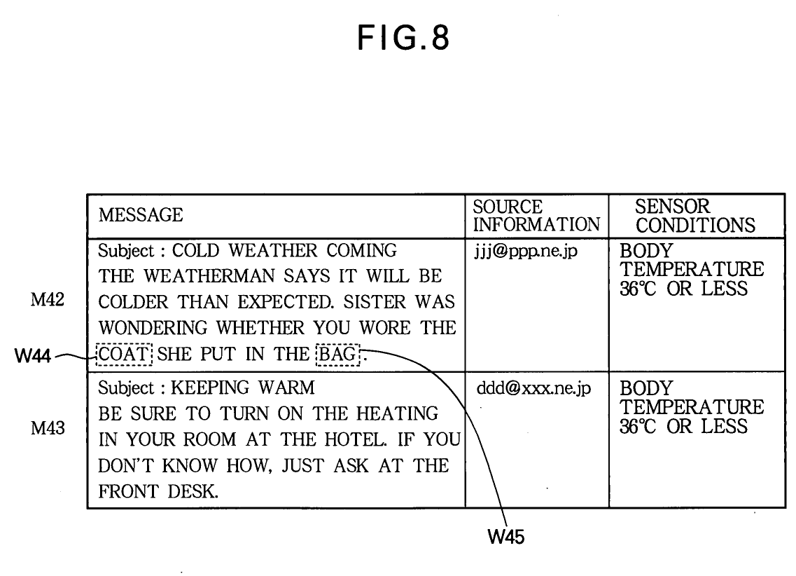

The operation of the fourth embodiment will be described below with reference to messages M42 and M43 in FIG. 8. It will be assumed that messages M42 and M43 and their source information and sensor conditions have already been stored in the message storage unit 3030 by the message input unit 3010, but have not been read with the message reading unit 20; the associated has-read flags accordingly indicate the unread condition.

It will be also assumed that the message input unit 3010 has now received the electronic mail M10 shown in FIG. 2A as an input message, including source information and the sensor condition ‘body temperature 36.0° C. or less’. Like the message input unit 10 in the first embodiment described above (FIG. 1), the message input unit 3010 extracts the source information and sensor condition, but the message input unit 3010 invokes the condition searcher 3050 before storing message M10 and its source information and sensor condition in the message storage unit 3030.

The condition searcher 3050 compares the sensor condition ‘body temperature 36.0° C. or less’ of electronic mail M10 with the sensor conditions of unread messages; stored in the message storage unit 3030, and thereby finds the messages M42 and M43 shown in FIG. 8. The similarity tester 3060 is invoked for messages M42 and M43.

The similarity tester 3060 extracts the nouns ‘coat’ and ‘bag’ as key character strings from the body H40 of message M10 in FIG. 2A when this message is input by the message input unit 3010. Message M42 in FIG. 8, which the condition searcher 3050 has found to have a matching sensor condition, also includes matching character strings W44 ‘bag’ and W45 ‘coat’. Accordingly, the similarity tester 3060 decides to invoke the notifier 3070 and thereby notify the sender of message M42. Message M43, which the condition searcher 3050 has also found to have a matching sensor condition, does not include any character strings matching ‘bag’ or ‘coat’, so the number of matching key character strings is zero, which is less than two, and the similarity tester 3060 decides not to invoke the notifier 3070 and thus not to notify the sender of message M43.

When invoked by the similarity tester 3060 for message M42 in the message storage unit 3030, the notifier 3070 uses the notification unit 80, which is a means for sending electronic mail, to send electronic mail to the mail address ‘jjj@ppp.ne.jp’ of the sender of message M42 to notify the sender of message M42 that this message, on the subject ‘cold weather coming’, has not been read, and that a newer and similar message with the subject ‘coat in bag’ has now been input from a party having mail address ‘ddd@xxx.ne.jp’.

Together with this notification, the notifier 3070 gives the sender of message M42 an opportunity to cancel message M42. The sender can compare messages M42 and M10, decide that they have similar content, and cancel message M42 to spare the recipient the trouble of reading and deleting it.

When message M11 in FIG. 2B is received and the condition searcher 3050 is invoked, since the sensor condition ‘2000 or more steps walked per hour’ associated with message M11 is not similar to the body-temperature sensor condition associated with the unread messages M42 and M43 (FIG. 8) stored in the message storage unit 3030, the condition searcher 3050 ends without further action being taken.

In processing messages in the Japanese language, the similarity tester 3060 in the fourth embodiment may extract character strings including at least a predetermined number of characters of a predetermined type in the body of the message input by the message input unit 3010. For example, it may extract strings of two or more consecutive kanji characters and strings of two or more consecutive katakana characters as key character strings. The similarity of a message for which the similarity tester 3060 is invoked by the condition searcher 3050 is then the number of matching strings of consecutive kanji characters or consecutive katakana characters.

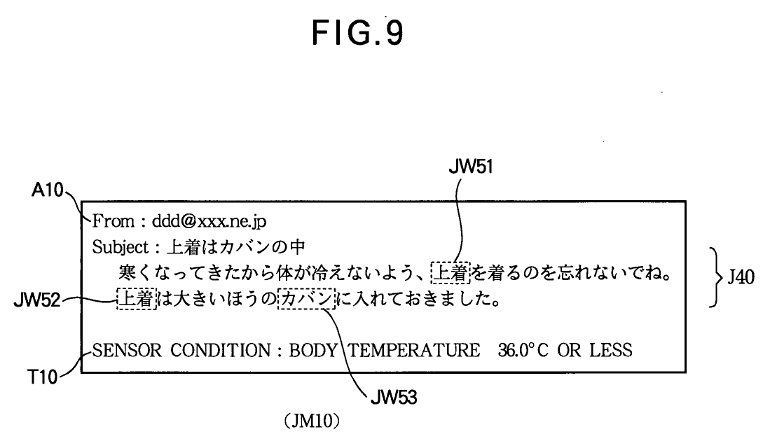

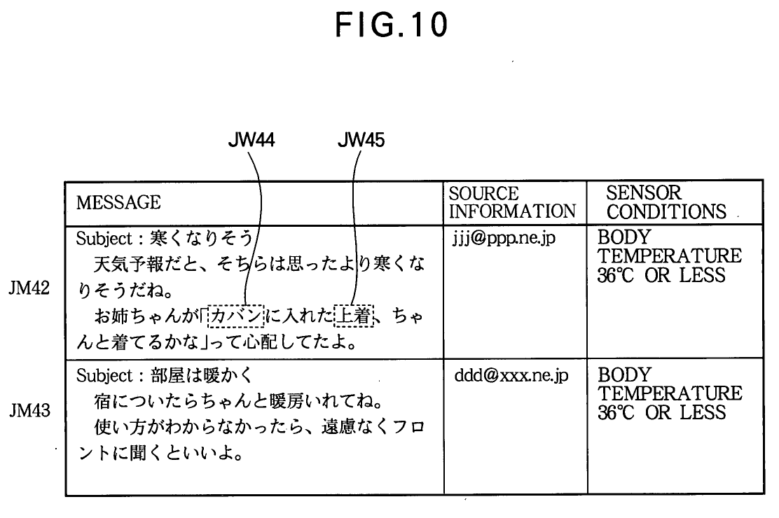

For example, FIG. 9 shows a Japanese version JM10 of message M10 and FIG. 10 shows Japanese versions JM42, JM43 of messages M42 and M43. The similarity tester 3060 extracts key character strings JW51 and JW52 (‘uwagi’), each consisting of two consecutive kanji characters, and key character string JW53 (‘kaban’), consisting of three consecutive katakana characters, from the body J40 of Japanese message JM10; finds two matching character strings JW44 (‘kaban’) and JW45 (‘uwagi’) in Japanese message JM42; but finds no matching character strings in Japanese message JM43. The similarity tester 3060 therefore invokes the notifier 3070 for message JM42 but not for message JM43.

According to the fourth embodiment described above, when a previous message stored in the message storage unit but not yet read and a newly input message have the same sensor conditions, and at least a predetermined number of similarities exist between the messages, the sender of the previous message is notified. If the newly input message supercedes the previous message, the sender of the previous message can cancel the previous message, thereby improving the efficiency of electronic mail communication for both the message recipient, who does not have to read two messages of similar content, and the sender of the previous message, who need no longer be concerned as to whether or not the message has been read.

Overall, the invention is applicable to message management apparatus that receives messages that need especially to be read under certain conditions specified by information attached to or provided in the messages and sensed by sensors. The invention enables another person, either the message sender or a third party, to help the message recipient take appropriate action on the message. Besides assisting the message recipient, this feature improves the efficiency of electronic mail communication for the message sender, in that fewer messages are sent in vain. The invention also improves the efficiency of electronic mail communication by enabling the senders of messages that have become redundant to cancel their messages.

The invention is particularly useful in an electronic mail terminal used by an elderly person whose condition is being monitored by sensors such as, for example, a thermometer, a pedometer, and a blood pressure gauge. For such a person, who may not be capable of reacting appropriately to a message even after reading the message, or may forget or be unwilling to take appropriate action, the invention can provide necessary third-party assistance, or assistance from the message sender, if the message recipient's condition as sensed by the sensors remains unfavorable for a significant period of time.

The invention is not limited to the embodiments described above. Those skilled in the art will recognize that further variations are possible within the scope of the invention, which is defined in the appended claims.

1. A message management apparatus comprising:
a message storage unit for storing messages, sensor conditions, and source information;
a message input unit for receiving messages and storing the messages, together with associated sensor conditions and source information, in the message storage unit;
a message reading unit for displaying the messages stored in the message storage unit, thereby enabling a person to read the messages;
a set of sensors, the set including at least one sensor;
a sensor condition tester for determining whether values sensed by the set of sensors satisfy the sensor conditions associated with the messages stored in the message storage unit;
a duration tester for deciding, for each message having a satisfied sensor condition, whether the sensor condition has been satisfied for at least a first predetermined time; and
a notifier for using the source information associated with a message having a sensor condition that has been satisfied for at least the first predetermined time to identify a sender of the message, and notifying the sender by sending the sender information identifying the message.

2. The message management apparatus of claim 1, wherein the sensor condition tester, the duration tester, and the notifier process only messages that have not yet been read with the message reading unit.

3. The message management apparatus of claim 1, wherein:
the duration tester decides, for each message having a satisfied sensor condition, whether the sensor condition has been satisfied continuously for at least the first predetermined time, and also decides whether the message has been read with the message reading unit within a second predetermined time; and
the notifier notifies the sender only if the sensor condition associated with the message has been satisfied continuously for at least the first predetermined time and the message has been read with the message reading unit within the second predetermined time.

4. The message management apparatus of claim 1, wherein:
the messages comprise electronic mail;
the source information comprises electronic mail addresses of senders of the messages; and
the notifier notifies the sender by sending electronic mail to an electronic mail address of the sender, the electronic mail address being indicated by the source information.

5. A message management apparatus comprising:
a message storage unit for storing messages and sensor conditions;
a message input unit for receiving messages and storing the messages, together with associated sensor conditions and source information, in the message storage unit;
a message reading unit for displaying the messages stored in the message storage unit, thereby enabling a person to read the messages;
a set of sensors, the set including at least one sensor;
a sensor condition tester for determining whether values sensed by the set of sensors satisfy the sensor conditions associated with the messages stored in the message storage unit;
a duration tester for deciding, for each message having a satisfied sensor condition, whether the sensor condition has been satisfied for at least a first predetermined time; and
a discloser for disclosing a message having a sensor condition that has been satisfied for at least the first predetermined time to a third party different from the sender of the message and the recipient of the message.

6. The message management apparatus of claim 5, wherein the sensor condition tester, the duration tester, and the discloser process only messages that have not yet been read with the message reading unit.

7. The message management apparatus of claim 5, wherein:
the duration tester decides, for each message having a satisfied sensor condition, whether the sensor condition has been satisfied continuously for at least the first predetermined time, and also decides whether the message has been read with the message reading unit within a second predetermined time; and
the discloser discloses the message to the third party only if the sensor condition associated with the message has been satisfied continuously for at least the first predetermined time and the message has been read with the message reading unit within the second predetermined time.

8. The message management apparatus of claim 5, further comprising a disclosure destination information supply unit for supplying disclosure destination information identifying the third party to the discloser.

9. The message management apparatus of claim 8, wherein the disclosure destination information supply unit provides different disclosure destination information for different messages.

10. The message management apparatus of claim 8, wherein the disclosure destination information supply unit provides different disclosure destination information for different dates and times.

11. The message management apparatus of claim 5, wherein the message input unit encodes the received messages and stores the received messages in the message storage unit in encoded form; and
the discloser decodes the messages when disclosing them.

12. The message management apparatus of claim 5, wherein the discloser discloses the message by enabling the third party to read the message with the message reading unit.

14. The message management apparatus of claim 5, wherein:
the messages comprise electronic mail;
the disclosure destination information comprises electronic mail addresses of the third party; and
the discloser discloses the message by sending electronic mail to the electronic mail address indicated by the disclosure destination information.

15. A message management apparatus comprising:
a message storage unit for storing messages, sensor conditions, and source information;
a message input unit for receiving messages and storing the messages, together with associated sensor conditions and source information, in the message storage unit;
a set of sensors, the set including at least one sensor;
a message reading unit for displaying the messages stored in the message storage unit, thereby enabling a person to read the messages, according to the sensor conditions associated with the messages and the output of the set of sensors;
a condition searcher for comparing the sensor conditions associated with the messages stored in the message storage unit with the sensor conditions associated with messages newly received by the message input unit to find stored messages having sensor conditions similar to the sensor conditions associated with the newly received messages; and
a notifier for using the source information associated with a stored message having a sensor condition similar to a sensor condition of a newly received message to identify a sender of the stored message, and notifying the sender by sending the sender information identifying the stored message.

16. The message management apparatus of claim 15, further comprising a similarity tester for performing natural language processing to determine a degree of similarity between content of each stored message having a sensor condition similar to the sensor condition of the newly received message and content of the newly received message, wherein the notifier notifies the sender of the stored message only if the stored message has at least a predetermined degree of similarity to the newly received message.

17. The message management apparatus of claim 16, wherein the similarity tester determines the degree of similarity by performing a morphological analysis of the newly received message to extract key words having a predetermined part of speech and searching for the key words in said each stored message, the degree of similarity of a stored-message being indicated by the number of matching key words found in the stored message.

18. The message management apparatus of claim 16, wherein the similarity tester determines the degree of similarity of messages in the Japanese language by extracting strings of consecutive characters of a predetermined type from a newly received message and searching for identical strings of characters in said each stored message, the degree of similarity of a stored message being indicated by the number of matching character strings found in the stored message.

19. The message management apparatus of claim 15, wherein:
the messages comprise electronic mail;
the source information comprises electronic mail addresses of senders of the messages; and
the notifier notifies the sender by sending electronic mail to an electronic mail address of the sender, the electronic mail address being indicated by the source information.
